(19) United States
(12) Patent Application Publication
(10) Pub. No.: US 2010/0322892 A1
(43) Pub. Date: Dec. 23, 2010

(54) PESTICIDE COMPOSITIONS AND APPLICATORS

(75) Inventor: Terrence R. Burke, Kirkwood, MO (US)

Correspondence Address: Patent Docket Department;Armstrong Teasdale LLP, 7700 Forsyth Boulevard, Suite 1800, St. Louis, MO, 63105, US

(73) Assignee: BASF CORPORATION, Florham Park, NJ (US)

(21) Appl. No.: 12/769,320

(22) Filed: Apr. 28, 2010

Related U.S. Application Data
(60) Provisional application No. 61/173,261, filed on Apr. 28, 2009.

(51) Int. Cl. A01N 43/16; A01P 19/00; A01P 7/04; A01P 7/00; B65D 83/14

(52) U.S. Cl. 424/84; 222/394

(57) ABSTRACT

Ready-to-use pesticide compositions that contain a solvent, a pesticide dissolved in the solvent, a particulate attractant and/or cellulose suspended throughout the solvent and a thickening agent. Applicators and methods for treating pests such as arthropods by dispensing the composition are also provided.

### CROSS-REFERENCE TO RELATED APPLICATION

This application claims the benefit of U.S. Provisional Application No. 61/173,261, filed Apr. 28, 2009, which is incorporated herein in its entirety.

### BACKGROUND

The field of the disclosure relates to pesticide compositions and, more particularly, ready-to-use pesticide compositions that contain a pesticide and a particulate material which attracts pests (i.e., “attractant”). The field of the disclosure also relates to pesticide applicators and methods for controlling pests. The pesticide compositions of embodiments of the present disclosure are well-suited for general application but are particularly well-suited for treating arthropods including insects and, particularly, for treating termites.

Insects and other arthropod pests can have negative effects on the quality of human life. For instance, when found in the home, insects and other arthropods can be a source of annoyance due purely to their presence. They may also spread disease and allergens. Additionally, when found on plants and crops, insects and other arthropods can destroy foliage and fruit, and may adversely affect plant and crop growth, quality, and yield.

Among the insects which are particularly undesirable are termites. Termites are well known for their destructive effects on residences, businesses and various other structures. The damage from termite infestations results in huge economic losses, structural safety concerns, and destruction of architecturally valuable structures.

It is domestically and commercially desirable to control termites through the use of pesticide products. It is also desirable to control other crawling arthropods, such as cockroaches, beetles, earwigs, silverfish, crickets, spiders, centipedes, millipedes, scorpions, pillbugs, sowbugs and various flying insects including flies, mosquitoes, gnats, moths, wasps, hornets, bees and the like.

A broad range of compounds have been found to be toxic to insects and other arthropods such that formulations containing the compounds may be used for their control. For example, termites are capable of control through sub-grade toxic-containing bait stations located along the perimeter of commercial and residential structures. There is a continuing need for methods for controlling pests such as termites that involve controlling and baiting the pests at the location at which the pests feed or are likely to feed and at which the pests are most destructive such as within the commercial and residential structures themselves.

### SUMMARY

In one aspect of the present disclosure, a ready-to-use pesticide composition includes a solvent, a pesticide dissolved in the solvent, a particulate attractant suspended in the solvent and a thickening agent.

Another aspect of the present disclosure is directed to a pesticide applicator for applying pesticide to pests. The applicator includes a container and a pesticide composition within the container. The pesticide composition includes a solvent, a pesticide dissolved in the solvent, a particulate attractant suspended in the solvent and a thickening agent.

In a further aspect of the present disclosure, a method for controlling pests includes dispensing a pesticide composition. The pesticide composition includes a solvent, a pesticide dissolved in the solvent, a particulate attractant suspended in the solvent and a thickening agent. The solvent vaporizes after the composition is dispensed. In accordance with the method, a target surface, space, void or crevice is contacted with the pesticide and attractant.

In another aspect, a ready-to-use pesticide composition includes a solvent, a pesticide dissolved in the solvent, particulate cellulose material suspended in the solvent and a thickening agent. The particulate cellulose material is selected from the group consisting of microcrystalline cellulose, purified cellulose, α-cellulose and mixtures thereof.

In yet another aspect, a ready-to-use pesticide composition for controlling termites includes a solvent, a pesticide dissolved in the solvent, a particulate termite attractant and a thickening agent.

Various refinements exist of the features noted in relation to the above-mentioned aspects of the present invention. Further features may also be incorporated in the above-mentioned aspects of the present invention as well. These refinements and additional features may exist individually or in any combination. For instance, various features discussed below in relation to any of the illustrated embodiments of the present invention may be incorporated into any of the above-described aspects of the present invention, alone or in any combination.

### BRIEF DESCRIPTION OF THE DRAWINGS

FIG. 1 is a front-side view of a pesticide applicator according to one embodiment of the present disclosure;

FIG. 2 is a front-side view of a pesticide applicator according to a second embodiment of the present disclosure; and

FIG. 3 is an exploded perspective view of a pesticide applicator according to a third embodiment of the present disclosure.

Corresponding reference characters indicate corresponding parts throughout the drawings.

### DETAILED DESCRIPTION

Among the provisions of the present disclosure are ready-to-use pesticide compositions, pesticide applicators and methods for controlling pests. It has been found that in embodiments of the present disclosure, a toxic chemical (e.g., fipronil) may generally be included in a composition that includes a solvent and a particulate material that attracts pests (i.e., “attractant”). Upon dispensing of the composition from its container, the solvent vaporizes leaving behind the active pesticide and particulate attractant. The pesticide may attach directly to the target surface or may attach to the attractant. The small particle size of the attractant allows the attractant and any pesticide attached to it to better adhere to the surface to which it is applied, such as, for example, vertical walls. Pests such as termites are drawn to the attractant (e.g., as when cellulose is used as an attractant) and generally come into contact with it. Upon contacting the attractant, the pest also contacts the pesticide which is toxic to the pest. The fine particle size of the attractant and the pesticide may cause the compounds to attach to the pest's exoskeleton generally allowing the pesticide to be carried to the nest or colony for control of the entire pest population.

### Ready-to-Use Pesticide Composition

In one embodiment of the present disclosure, a ready-to-use pesticide composition is provided. For purposes of the present disclosure, “ready-to-use” refers to compositions that are not in a concentrate form but rather which may be applied without modification of the relative amounts of components within the product. In this regard, as used herein, the term “pesticide” refers to any substance or mixture for preventing, destroying, repelling, or mitigating various pests and, particularly, for controlling arthropods (e.g., insects). As used herein, the term “pesticide” in not intended to include other materials which may conventionally fall within the scope of the term “pesticide” as used in the art including, for example, herbicides, bactericides and fungicides. The term “arthropodicide”, which is a type of pesticide, is used herein to mean any substance or mixture for preventing, destroying, repelling, or mitigating arthropods. The term “insecticide”, which is a type of pesticide, is used herein to mean any substance or mixture for preventing, destroying, repelling, or mitigating insects. The term “termiticide”, which is a type of insecticide, is used herein to mean any substance or mixture for preventing, destroying, repelling, or mitigating termites.

Suitable pesticides which may be included in the compositions of the present disclosure (and particularly, suitable arthropodicides and/or insecticides) include the following list of compounds (“M compounds”):
(M1) Organo(thio)phosphate compounds: acephate, azamethiphos, azinphos-ethyl, azinphos-methyl, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, flupyrazophos, fosthiazate, heptenophos, isoxathion, malathion, mecarbam, methamidophos, methidathion, mevinphos, monocrotophos, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon and vamidothion;
(M2) carbamate compounds: aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb and triazamate;
(M3) pyrethroid compounds: acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, metofluthrin, permethrin, phenothrin, prallethrin, profluthrin, pyrethrin (pyrethrum), resmethrin, silafluofen, tefluthrin, tetramethrin, tralomethrin and transfluthrin;
(M4) juvenile hormone mimics: hydroprene, kinoprene, methoprene, fenoxycarb and pyriproxyfen;
(M5) nicotinic receptor agonists/antagonists compounds: acetamiprid, bensultap, cartap hydrochloride, clothianidin, dinotefuran, imidacloprid, thiamethoxam, nitenpyram, nicotine, spinosad (allosteric agonist), spinetoram (allosteric agonist), thiacloprid, thiocyclam, thiosultap-sodium and AKD1022;
(M6) GABA gated chloride channel antagonist compounds: chlordane, endosulfan, gamma-HCH (lindane); ethiprole, fipronil, pyrafluprole and pyriprole
(M7) chloride channel activators: abamectin, emamectin benzoate, milbemectin and lepimectin;
(M8) METI I compounds: fenazaquin, fenpyroximate, pyrimidifen, pyridaben, tebufenpyrad, tolfenpyrad, flufenerim, rotenone;
(M9) METI II and III compounds: acequinocyl, fluacyprim and hydramethylnon;
(M10) uncouplers of oxidative phosphorylation: chlorfenapyr and DNOC;
(M11) inhibitors of oxidative phosphorylation: azocyclotin, cyhexatin, diafenthiuron, fenbutatin oxide, propargite and tetradifon;
(M12) moulting disruptors: cyromazine, chromafenozide, halofenozide, methoxyfenozide and tebufenozide;
(M13) synergists: piperonyl butoxide and tribufos;
(M14) sodium channel blocker compounds: indoxacarb and metaflumizone;
(M15) selective feeding blockers: crylotie, pymetrozine and flonicamid;
(M16) mite growth inhibitors: clofentezine, hexythiazox and etoxazole;
(M17) chitin synthesis inhibitors: buprofezin, bistrifluron, chlorfluazuron, diflubenzuron, flucycloxuron, flufenoxuron, hexaflumuron, lufenuron, novaluron, noviflumuron, teflubenzuron and triflumuron;
(M18) lipid biosynthesis inhibitors: spirodiclofen, spiromesifen and spirotetramat;
(M19) octapaminergic agonsits: amitraz;
(M20) ryanodine receptor modulators: flubendiamide and the phtalamid compound (R)-, (S)-3-Chlor-N1-{2-methyl-4-[1,2,2,2-tetrafluor-1-(trifluormethyl)ethyl]phenyl}-N2-(1-methyl-2-methylsulfonylethyl)phthalamid (M20.1);
(M21) isoxazoline compounds: 4-[5-(3,5-Dichloro-phenyl)-5-trifluoromethyl-4,5-dihydro-isoxazol-3-yl]-2-methyl-N-pyridin-2-ylmethyl-benzamide (M21.1), 4-[5-(3,5-Dichloro-phenyl)-5-trifluoromethyl-4,5-dihydro-isoxazol-3-yl]-2-methyl-N-(2,2,2-trifluoro-ethyl)-benzamide (M21.2), 4-[5-(3,5-Dichloro-phenyl)-5-trifluoromethyl-4,5-dihydro-isoxazol-3-yl]-2-methyl-N-[(2,2,2-trifluoro-ethylcarbamoyl)-methyl]-benzamide (M21.3), 4-[5-(3,5-Dichloro-phenyl)-5-trifluoromethyl-4,5-dihydro-isoxazol-3-yl]-naphthalene-1-carboxylic acid [(2,2,2-trifluoro-ethylcarbamoyl)-methyl]-amide (M21.4), 4-[5-(3,5-Dichlorophenyl)-5-trifluoromethyl-4,5-dihydro-isoxazol-3-yl]-N-[(methoxyimino)methyl]-2-methylbenzamide (M21.5) 4-[5-(3-Chloro-5-trifluoromethyl-phenyl)-5-trifluoromethyl-4,5-dihydro-isoxazol-3-yl]-2-methyl-N-[(2,2,2-trifluoro-ethylcarbamoyl)-methyl]-benzamide (M21.6), 4-[5-(3-Chloro-5-trifluoromethyl-phenyl)-5-trifluoromethyl-4,5-dihydro-isoxazol-3-yl]-naphthalene-1-carboxylic acid [(2,2,2-trifluoro-ethylcarbamoyl)-methyl]-amide (M21.7) and 5-[5-(3,5-Dichloro-4-fluoro-phenyl)-5-trifluoromethyl-4,5-dihydro-isoxazol-3-yl]-2-[1,2,4]triazol-1-yl-benzonitrile (M21.8);

(M22) anthranilamide compounds: chloranthraniliprole, cyantraniliprole, 5-Bromo-2-(3-chloro-pyridin-2-yl)-2H-pyrazole-3-carboxylic acid [4-cyano-2-(1-cyclopropyl-ethylcarbamoyl)-6-methyl-phenyl]-amide (M22.1), 5-Bromo-2-(3-chloro-pyridin-2-yl)-2H-pyrazole-3-carboxylic acid [2-chloro-4-cyano-6-(1-cyclopropyl-ethylcarbamoyl)-phenyl]-amide (M22.2), 5-Bromo-2-(3-chloro-pyridin-2-yl)-2H-pyrazole-3-carboxylic acid [2-bromo-4-cyano-6-(1-cyclopropyl-ethylcarbamoyl)-phenyl]-amide (M22.3), 5-Bromo-2-(3-chloro-pyridin-2-yl)-2H-pyrazole-3-carboxylic acid [2-bromo-4-chloro-6-(1-cyclopropyl-ethylcarbamoyl)-phenyl]-amide (M22.4), 5-Bromo-2-(3-chloro-pyridin-2-yl)-2H-pyrazole-3-carboxylic acid [2,4-dichloro-6-(1-cyclopropyl-ethylcarbamoyl)-phenyl]-amide (M22.5), 5-Bromo-2-(3-chloro-pyridin-2-yl)-2H-pyrazole-3-carboxylic acid [4-chloro-2-(1-cyclopropyl-ethylcarbamoyl)-6-methyl-phenyl]-amide (M22.6), N′-(2-{[5-Bromo-2-(3-chloro-pyridin-2-yl)-2H-pyrazole-3-carbonyl]-amino}-5-chloro-3-methyl-benzoyl)-hydrazinecarboxylic acid methyl ester (M22.7), N′-(2-{[5-Bromo-2-(3-chloro-pyridin-2-yl)-2H-pyrazole-3-carbonyl]-amino}-5-chloro-3-methyl-benzoyl)-N′-methyl-hydrazinecarboxylic acid methyl ester (M22.8), N′-(2-{[5-Bromo-2-(3-chloro-pyridin-2-yl)-2H-pyrazole-3-carbonyl]-amino}-5-chloro-3-methyl-benzoyl)-N,N′-dimethyl-hydrazinecarboxylic acid methyl ester (M22.9), N′-(3,5-Dibromo-2-{[5-bromo-2-(3-chloro-pyridin-2-yl)-2H-pyrazole-3-carbonyl]-amino}-benzoyl)-hydrazinecarboxylic acid methyl ester (M22.10), N′-(3,5-Dibromo-2-{[5-bromo-2-(3-chloro-pyridin-2-yl)-2H-pyrazole-3-carbonyl]-amino}-benzoyl)-N′-methyl-hydrazinecarboxylic acid methyl ester (M22.11) and N′-(3,5-Dibromo-2-{[5-bromo-2-(3-chloro-pyridin-2-yl)-2H-pyrazole-3-carbonyl]-amino}-benzoyl)-N,N′-dimethyl-hydrazinecarboxylic acid methyl ester (M22.12);
(M23) malononitrile compounds: 242,2,3,3,4,4,5,5-octafluoropentyl)-2-(3,3,3-trifluoro-propyl)malononitrile (CF2H—CF2-CF2-CF2-CH2-C(CN)2-CH2-CH2-CF3) (M23.1) and 2-(2,2,3,3,4,4,5,5-octafluoropentyl)-2-(3,3,4,4,4-pentafluorobutyl)-malonodinitrile (CF2H—CF2-CF2-CF2-CH2-C(CN)2-CH2-CH2-CF2-CF3) (M23.2);
(M24) microbial disruptors: Bacillus thuringiensis subsp. Israelensi, Bacillus sphaericus, Bacillus thuringiensis subsp. Aizawai, Bacillus thuringiensis subsp. Kurstaki and Bacillus thuringiensis subsp. Tenebrionis;
(M25) aminofuranone compounds: 4-{[(6-Bromopyrid-3-yl)methyl](2-fluoroethyl)amino}furan-2(5H)-on (M25.1), 4-{[(6-Fluoropyrid-3-yl)methyl](2,2-difluoroethyl)amino}furan-2(5H)-on (M25.2), 4-{[(2-Chloro1,3-thiazolo-5-yl)methyl](2-fluoroethyl)amino}furan-2(5H)-on (M25.3), 4-{[(6-Chloropyrid-3-yl)methyl](2-fluoroethyl)amino}furan-2(5H)-on (M25.4), 4-{[(6-Chloropyrid-3-yl)methyl](2,2-difluoroethyl)amino}furan-2(5H)-on (M25.5), 4-{[(6-Chloro-5-fluoropyrid-3-yl)methyl](methyl)amino}furan-2(5H)-on (M25.6), 4-{[(5,6-Dichloropyrid-3-yl)methyl](2-fluoroethyl)amino}furan-2(5H)-on (M25.7), 4-{[(6-Chloro-5-fluoropyrid-3-yl)methyl](cyclopropyl)amino}furan-2(5H)-on (M25.8), 4-{[(6-Chloropyrid-3-yl)methyl](cyclopropyl)amino}furan-2(5H)-on (M25.9) and 4-{[(6-Chloropyrid-3-yl)methyl](methyl)amino}furan-2(5H)-on (M25.10);
(M26) various compounds: amidoflumet, benclothiaz, benzoximate, bifenazate, borax, bromopropylate, cyenopyrafen, cyflumetofen, chinomethionate, dicofol, fluoroacetate, pyridalyl, pyrifluquinazon, tartar emetic, sulfoxaflor, N-R′-2,2-dihalo-1-R″cyclo-propanecarboxamide-2-(2,6-dichloro-α,α,α-trifluoro-p-tolyl)hydrazone or N-R′-2,2-di(R′″)propionamide-2-(2,6-dichloro-α,α,α-trifluoro-p-tolyl)-hydrazone, wherein R′ is methyl or ethyl, halo is chloro or bromo, R″ is hydrogen or methyl and R″' is methyl or ethyl, 4-But-2-ynyloxy-6-(3,5-dimethyl-piperidin-1-yl)-2-fluoro-pyrimidine (M26.1), Cyclopropaneacetic acid, 1,1′-[(3S,4R,4aR,6S,6aS,12R,12aS,12bS)-4-[[(2-cyclopropylacetyl)oxy]methyl]-1,3,4,4a,5,6,6a,12,12a,12b-decahydro-12-hydroxy-4,6a,12b-trimethyl-11-oxo-9-(3-pyridinyl)-2H,11H-naphtho[2,1-b]pyrano[3,4-e]pyran-3,6-diyl]ester (M26.2) and 8-(2-Cyclopropylmethoxy-4-trifluoromethyl-phenoxy)-3-(6-trifluoromethyl-pyridazin-3-yl)-3-aza-bicyclo[3.2.1]octane (M26.3).

The commercially available compounds described above may be found in The Pesticide Manual, 13th Edition, British Crop Protection Council (2003) among other publications.

Paraoxon and their preparation have been described in Farm Chemicals Handbook, Volume 88, Meister Publishing Company, 2001. Flupyrazofos has been described in Pesticide Science 54, 1988, p. 237-243 and in U.S. Pat. No. 4,822,779. AKD 1022 and its preparation have been described in U.S. Pat. No. 6,300,348. The anthranilamides M22.1 to M22.6 have been described in WO 2008/72743 and WO 200872783 and M22.7 to M22.12 have been described in WO 2007/043677. The phthalamide M20.1 is known from WO 2007/101540. The alkynylether compound M26.1 is described in, for example, JP 2006131529. Organic sulfur compounds have been described in WO 2007/060839. The isoxazoline compounds M 21.1 to M21.8 have been described in, for example, WO 2005/085216, WO 2007/079162, WO 2007/026965, WO 2009/126668 and WO 2009/051956. The aminofuranone compounds M25.1 to M25.10 have been described in, for example, WO 2007/115644. The pyripyropene derivative M 26.2 has been described in WO 2008/66153 and WO 2008/108491. The pyridazin compound M26.3 has been described in JP 2008/115155. Malononitrile compounds as M23.1 and M23.2 have been described in WO 02/089579, WO 02/090320, WO 02/090321, WO 04/006677, WO 05/068423, WO 05/068432 and WO 05/063694.

In certain embodiments, the pesticide is fipronil (synonymously “fluocyanobenpyrazole”). Fipronil is known chemically as (±)-5-amino-1-(2,6-dichloro-α,α,α-trifluoro-p-tolyl)-4-trifluoromethylsulfinylpyrazole-3-carbonitrile and is available in technical grades or commercially as a concentrate such as, for example TERMIDOR® SC. The structure of fipronil is illustrated in Formula (I) below,

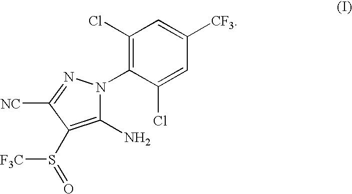

Fipronil has been found effective in treatment of many pests including, for example, termites, ants, beetles, cockroaches, fleas, ticks, mole crickets, thrips, rootworms and weevils. Generally, fipronil may be toxic to termites at a dose of 2 nanograms per termite and may be toxic to ants at a dose of about 1 nanogram per ant.

The amount of pesticide utilized in the pesticide composition may vary depending on the intended use of the composition including, for example, the pests intended for control. In one embodiment, a pest is contacted with the pesticide composition in a pesticidally effective amount. For purposes of the present disclosure, a “pesticidally effective amount” of the composition includes amounts that repel the pest and may include, in another embodiment, amounts of the composition that kill the pest. When fipronil is used as the pesticide, the composition comprises at least about 0.005% by weight fipronil and, in other embodiments at least about 0.01%, at least about 0.03%, at least about 0.05% or even at least about 0.1% by weight fipronil. In various other embodiments, the composition comprises from about 0.01% to about 0.5% by weight fipronil or from about 0.05% to about 0.5% by weight fipronil. When a pesticide other than fipronil is utilized (such as each of those listed as M compounds including abamectin, dinotefuran, diflubenzuron, chlroatraniprole, indoxacarb or novaluron) the composition may include at least about 0.01% by weight pesticide and, in other embodiments, at least about 0.05% or even at least about 0.1% by weight pesticide. The amount of pesticide included in the composition may vary from the amounts listed above (as dependent on, for example, the target pest, desired kill time, pesticidal activity of the active and the like) and suitable amounts may be readily determined by those of skill in the art by routine experimentation.

As described above, the pesticide may be dissolved in the solvent of the pesticide composition. The solvent may be selected from the group consisting of, isoparaffins, acetone, alcohols, esters, ethers and mixtures thereof. In some embodiments, the solvent is acetone and, in certain other embodiments, both an isoparaffin mixture and acetone are used as solvents. Generally, the composition comprises at least about 10% solvent by weight and, in other embodiments, comprises at least about 20% or even about 45% solvent by weight of the composition. For example, the composition may include from about 10% to about 40% or from about 20% to about 60% by weight solvent. In embodiments wherein more than one solvent is used (e.g., a co-solvent is used), the total amount of solvent in the pesticide composition may fall within the previously recited ranges. Typically, the solvent utilized in the composition is volatile such that the solvent vaporizes relatively quickly after being dispensed from a pressurized container.

In some embodiments of the present disclosure, a mixture of isoparaffins is used as a solvent. Non-polar solvents such as isoparaffins allow certain thickening agents which are described below to be functional. For example, bentonite clay is not active in certain polar solvents such as, for example, acetone; however, bentonite clay has been found to cause thickening of the pesticide composition when non-polar solvents are included in the composition. It is desirable, however, to limit the amount of certain solvents in the composition and, particularly, to limit the amount of solvents such as isoparaffins that are classified as volatile organic compounds (“VOC's”). Accordingly, it is preferred that the amount of VOC's (e.g., isoparaffins) in the composition be less than governmental standards such as, for example, less than about 15% by weight of the composition (e.g., from about 1% to about 15% by weight). In some particular embodiments of the present disclosure, a polar non-VOC solvent such as acetone is included in the composition as a solvent and a non-polar VOC co-solvent such as a mixture of isoparaffins is included for the thickening agent (e.g., bentonite clay) to be functional. In certain embodiments, the amount of the polar non-VOC solvent may be from about 5% to about 75% by weight of the composition (e.g., from about 10% to about 50% or from about 10% to about 25% by weight of the composition) and the amount of polar VOC co-solvent may be from about 1% to about 15% by weight of the composition.

In various embodiments, a pesticide is dissolved in the solvent and a particulate attractant is suspended throughout the solvent. In this regard, it should be understood that, as used herein, “attractant” refers to any material that causes a pest or pest population to be drawn towards it or drawn to a location in which the attractant is dispersed relative to the frequency at which the pests are drawn to the location in the absence of the attractant. Further in this regard, the attractant for use in the pesticide compositions of the present disclosure will vary depending on the pest targeted for control as will be appreciated by those of skill in the art. It should be noted that use of the term “attractant” herein does not imply that the material is attractive to all arthropods or even to more than one arthropod or that the material acts as an attractant relative to all species of an arthropod genus (e.g., to all termite species) and the use of the term “attractant” should not be viewed in a limiting sense.

Generally, unlike the pesticide, the particulate attractant does not dissolve in the solvent and instead is suspended throughout the solvent. It should be understood that one or more of the other additives such as a thickening agent, anti-caking agent and the like may not dissolve, partially dissolve or fully dissolve in the solvent and use of the term “solvent” is not meant to limit embodiments of the present disclosure to compositions wherein one or more components do or do not dissolve in the solvent. It should be further noted that the particulate attractant need not be uniformly dispersed throughout the pesticide composition and there may be localized concentrations that are higher or lower than the average concentration in the pesticide composition and use of the phrase “suspended throughout” should not be considered in a limiting sense.

Materials containing cellulose may be used as the attractant in accordance with the present disclosure. Cellulose has been found to be particularly attractive to termites. When cellulose is used as an attractant in accordance with the present disclosure, the cellulose may be microcrystalline cellulose, purified cellulose or α-cellulose. Other attractants include treated wood powder, materials containing sugar which are attractive to ants, wasps and bees and ground and freeze-dried insects such as crickets which are attractive to ants.

Regardless of the choice of attractant, the attractant preferably has a particle size of less than about 100 μm and, in other embodiments, is less than about 50 μm or even less than about 5 μm. In various other embodiments, the average nominal diameter of the attractant is from about 1 μm to about 100 μm, from about 1 μm to about 50 μm, from about 1 μm to about 30 μm or from about 10 μm to about 30 μm.

It has been found that relatively small particle sizes (e.g., from about 10 μm to about 30 μm) allow the pesticide composition to better adhere to the surface to which it is applied, such as, for example, vertical walls. It is believed that the small particle sizes increase the surface area of contact between the attractant (which may have the active pesticide attached thereto) and the surface to which it is applied which allows the composition to better adhere to the surface. Generally, the pesticide composition of embodiments of the present disclosures is capable of adhering to a vertical surface in a manner such that less than about 25% by weight of the pesticide composition after being applied and after drying dislodges from the vertical surface after about 72 hours of application. In other embodiments, less than about 15%, less than about 5% or less than about 1% by weight of the pesticide composition after being applied and after drying dislodges from the vertical surface after about 72 hours of application. In some particular embodiments, the pesticide composition is capable of adhering to a vertical surface such that substantially none of the pesticide composition after being applied and after drying dislodges from the vertical surface after about 72 hours of application (see Example 5).

When microcrystalline cellulose is used as the attractant, the particle size of the microcrystalline cellulose may be from about 1 μm to about 100 μm as disclosed in U.S. Pat. No. 6,416,752 which is incorporated herein for all relevant and consistent purposes. It has been found that particle sizes of from about 10 μm to about 30 μm and of about 20 μm are particularly advantageous as arthropods such as termites exhibit a relatively enhanced attraction to the attractants (e.g., microcrystalline cellulose) at this particle size range.

The composition may include at least about 2% by weight attractant (e.g., microcrystalline cellulose) and, in other embodiments at least about 5%, at least about 15% or even about 25% by weight attractant. In various other embodiments, the composition comprises from about 5% to about 70% by weight attractant, from about 5% to about 40%, from about 5% to about 15% or from about 20% to about 40% by weight attractant.

In some embodiments, the composition includes a thickening agent to increase the viscosity of the composition and to impart desirable fluid properties to the composition. Generally, natural or synthetic polysaccharide gums or clays may be used as a thickening agent. Among suitable polysaccharide thickening agents are xantham gum, guar gum, gum arabic, alginin, gum tragacanth, sodium alginate and mixtures thereof. In some embodiments, bentonite clay (e.g., organically modified bentonite clay) is used as a thickening agent. The composition may include at least about 0.1% thickening agent by weight and, in another embodiment, at least about 0.5% thickening agent by weight. In various embodiments, the pesticide composition includes from about 0.1% to about 5% thickening agent by weight of the composition, from about 0.1% to about 1% or from about 0.3% to about 1% thickening agent by weight of the composition. The composition may include more than one thickening agent with the total amount of thickening agents corresponding to the previously listed amounts.

The composition may optionally include an anti-caking agent to prevent the attractant (e.g., microcrystalline cellulose) within the storage vessel from caking at the bottom of the vessel. Suitable anti-caking agents include hydrophobic, hydrophilic, fume, precipitated and gel silica. In one embodiment, the anti-caking agent is hydrophilic fumed silica. The composition may include at least about 0.05% anti-caking agent and, in another embodiment, may include at least about 0.15% anti-caking agent. In yet another embodiment, the composition includes from about 0.15% to about 0.40% anti-caking agent by weight. In some embodiments, the pesticide composition does not contain an anti-caking agent.

In various embodiments of the present disclosure, after packaging, the composition generally is a colloidal dispersion and is applied as an aerosol. As packaged, the composition may also include propellants which pressurize the storage container and which create an aerosol upon application of the composition. The total amount of propellants in the pesticide composition may be at least about 10% by weight of the composition. Suitable propellants include, for example, propane, isobutane, dimethyl ether, difluoroethane, tetrafluoroethane, carbon dioxide and mixtures thereof.

In one embodiment, the composition is characterized by a pH of from about 6.5 to about 8 and, in another embodiment, by a pH of from about 7 to about 7.25. If the composition has a pH below about 6.5 to about 7, the container housing the composition may corrode with lower pH's corresponding to a higher rate of corrosion. Also, fipronil tends to be more active at a pH below about 8. The composition may be characterized by a pH other than those listed without departing from the scope of the present disclosure.

Generally, the composition is prepared by mixing all ingredients other than propellants in their relative proportions and, in one embodiment, as done in Examples 1, 2 or 3 below. All mixing can be done at room temperature. Once mixed, the composition is added to a suitable container and a propellant may be added if desired.

Generally, the composition is applied to a target void, crevice, space or surface. The composition may be applied to structural supports such as, for example, wood-based studs and beams. Once dispensed from its storage container, the solvent in the composition vaporizes and leaves behind residual pesticide. In some embodiments, the solvent dries after application to the target surface and, in another embodiment, the pesticide dries while being applied and the dried pesticide contacts the target surface. The pesticide may attach to the particulate attractant as the solvent vaporizes. The pesticide may attach to the particulate attractant by adsorption, absorption, adhesion, surface tension or as a coating.

In various embodiments, the solvent is capable of about 90% vaporization within about 5 minutes of application of the composition, within about 1 minute, within about 30 seconds of application of the composition or even within about 5 seconds of application of the composition. In one embodiment, the solvent is capable of about 90% vaporization prior to contacting the pesticide and attractant with the target surface.

### Pesticide Applicator

Embodiments of the ready-to-use pesticide composition described above may be incorporated into a pesticide applicator utilized for applying pesticides (e.g., fipronil) to pests. Generally, the applicator may include a container and a pesticide composition within the container. The pesticide composition may optionally include a solvent, a pesticide dissolved in the solvent, a particulate attractant and a thickening agent as generally described above. Other optional additives include anti-caking agents and/or propellants as described above.

Suitable containers may be constructed of, for example, three-piece tinplate, aluminum and PET-lined steel containers. The pesticide composition may be pressurized within the container by addition of a propellant. The total amount of propellants in the pesticide composition may be at least about 5% by weight of the composition and, in other embodiments, is at least about 10%, at least about 15%, at least about 35% or even at least about 50% by weight of the composition (e.g., from about 5% to about 35% by weight, from about 10% to about 30% by weight, from about 10% to about 75% or from about 50% to about 75% by weight). As stated above, suitable propellants include propane, isobutane, dimethyl ether, difluoroethane, tetrafluoroethane, carbon dioxide and mixtures thereof. In some embodiments, the composition comprises dimethyl ether and carbon dioxide as propellants and, in other embodiments, difluoroethane is used as a propellant. The propellants may be compressed gases, soluble gases or liquefied gases.

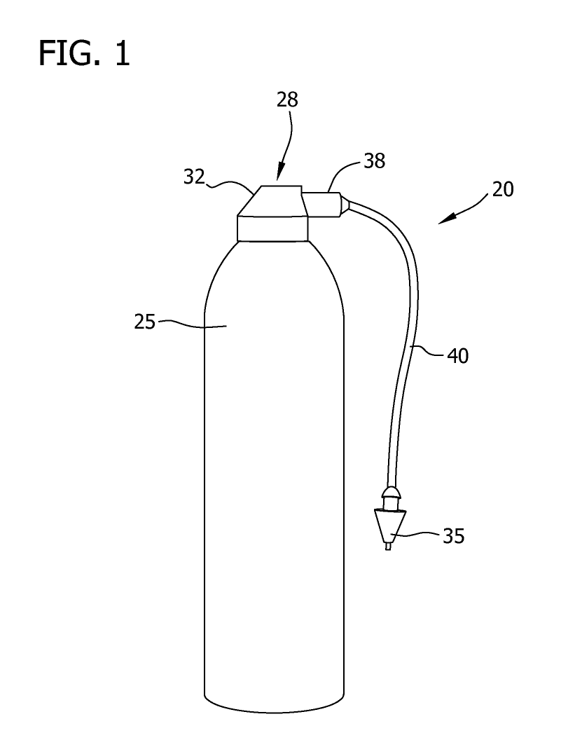

Referring now to FIG. 1, an embodiment of a pesticide applicator for storage and application of pesticide compositions of embodiments of the present disclosure is illustrated. The applicator 20 includes a container 25. The applicator 20 includes a pesticide composition (not shown) within the container 25 as described above. In one embodiment, the pesticide composition includes a solvent, a pesticide dissolved in the solvent and an attractant.

The pesticide applicator 20 includes a cap 28 which houses a valve (not shown). An actuator (not shown but generally located within or as part of the cap at 32) is connected to the valve for regulating the flow of the pesticide composition from the container 25. The actuator is sized and shaped for activation by a pressing force that may be provided by a human finger. The applicator 20 includes an exhaust port 38 that is fluidly connected to the container 25 upon activation of the actuator (i.e., opening of the valve). The injector tip 35 is fluidly connected to the exhaust port through a tube 40.

For purposes of the present disclosure, “fluidly connected” is meant to include, for example, arrangements in which a fluid is capable of flowing within after application of a differential fluid driving force such as, for example, a pressure difference.

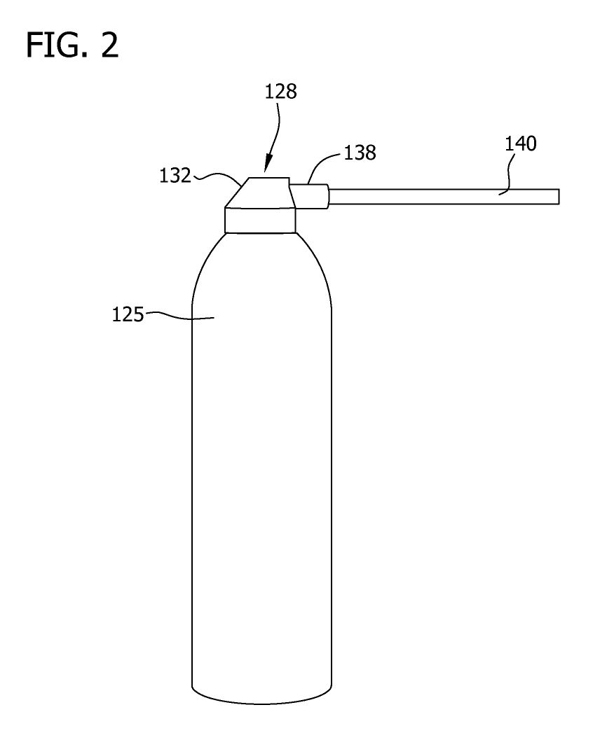

A second embodiment of an applicator of the present disclosure is illustrated in FIG. 2. The pesticide applicator 120 is similar to the applicator 20 of FIG. 1 however the applicator 120 does not include an injector tip. Also the tube 140 may be more rigid such that the user does not need to grasp and direct the tube to the area of application but rather can direct the direction of dispersion of the composition with the same hand used to activate the actuator. In one embodiment, the applicator does not include a tube 140 and the composition is applied through the exhaust port 138.

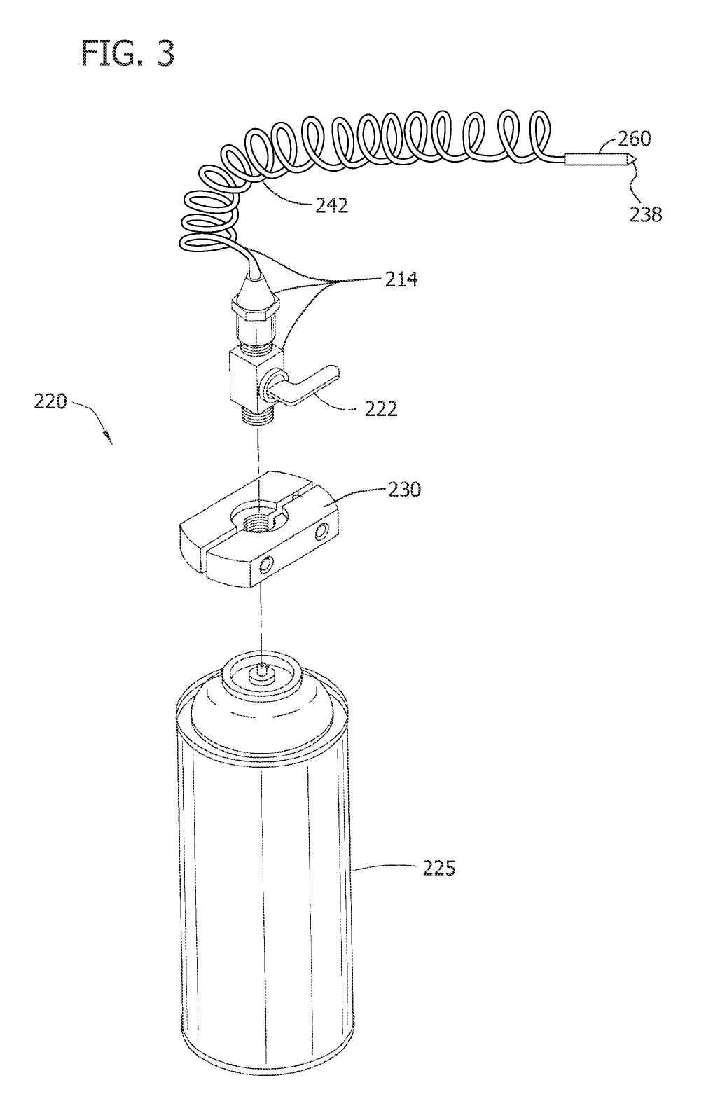

A third embodiment of an applicator of the present disclosure is illustrated in FIG. 3. The pesticide applicator 220 includes a container 225 (e.g., aerosol can) with an internal valve (not shown), an adaptor clamp 230 and a delivery system 214 as disclosed in U.S. Pat. No. 6,840,461 which is incorporated herein for all relevant and consistent purposes. As shown, the delivery system includes an extendible coiled hose 242, wand 260 and exhaust port 238; however, it should be understood that other delivery systems may be used without departing from the scope of the present disclosure. The composition is dispensed upon activation of the actuator 222.

In another embodiment, the applicator includes a pump that is actuated by hand. A suitable pump spraying apparatus is illustrated and described in U.S. Pat. No. 6,415,956 which is incorporated herein for all relevant and consistent purposes. In another embodiment, the pump is electrically powered. The pump may pull the composition into a chamber and blow the composition out of a tube similar to the tube 140 of FIG. 2.

Before application of the composition it may be desirable to shake the applicator so as to thoroughly mix the ingredients. In one embodiment, a small object is within the container such as, for example, a ¼ inch (6 mm) stainless steel ball. The object acts to accelerate the mixing of the ingredients.

Generally, the pesticide applicator may be used to control pests by dispensing the pesticide composition from the container and applying the composition to the target surface, space, void or crevice. The composition is generally an aerosol after application. The composition may be dispensed by, for example, applying a downward pressing force to the actuator of the applicator illustrated FIG. 1-3.

In various embodiments, the solvent is capable of about 90% vaporization within about 5 minutes of application of the composition, within about 1 minute, within about 30 seconds of application of the composition or even within about 5 seconds of application of the composition. In one embodiment, the solvent is capable of about 90% vaporization prior to the pesticide and attractant contacting the target surface. By increasing the distance between the point at which the composition exhausts from the applicator and the target surface, the solvent generally vaporizes more quickly. In some embodiments, the distance may be increased to a point at which about 90% of the solvent has vaporized (or even nearly about 100%) prior to contact of the pesticide and attractant with the target surface.

### Methods for Controlling Pests

In one embodiment of the present disclosure, a method for controlling pests includes dispensing a pesticide composition comprising a solvent, a pesticide dissolved in the solvent, a particulate attractant and a thickening agent from a container as described above. The solvent is vaporized after the composition is dispensed. A target surface, space, void or crevice is contacted with the pesticide and attractant. Other optional additives for the composition include anti-caking agents and/or propellants as described above.

In one embodiment, the pesticide attaches to the particulate attractant (e.g., microcrystalline cellulose) as the solvent vaporizes. It is believed that the composition may be dispensed as small droplets or a mist and, in some embodiments, even as an atomized mist. Solvent vaporizes from the individual droplets after dispensing and leaves behind the pesticide and particulate attractant with the pesticide being attached to the attractant. Without being bound to any particular theory, it is believed that the pesticide attaches to the particulate attractant by adsorption, absorption, adhesion, surface tension or even as a coating.

In another embodiment, the mist or droplets contact the target surface with solvent being present in the droplets. This may be desirable, in some embodiments, to assist the pesticide and particulate attractant in adhering to the target surface.

Generally, after application pests such as termites are drawn toward the attractant. In the course of coming into contact with the dry attractant the pests also contact the pesticide. The pests may also consume an amount of attractant and pesticide. The pesticide is generally toxic to the pest. The pest may carry (e.g., by adhesion or after consumption of pesticide-attached attractant) the pesticide back to its nesting area or colony where the pesticide may contact further pests. Generally, the small particle size of the pesticide and the attractant allow the pesticide and/or pesticide-attached attractant to adhere to the exoskeleton of the arthropod.

The pesticide composition may by applied to a vertical surface (e.g., termite runs, drywall, etc.) as the compositions of embodiments of the present disclosure are capable of adhering to vertical surface for relatively long periods of time. This allows for a greater rate of contact between the target pests and the pesticide composition. In some embodiments, less than about 25% by weight of the pesticide composition after being applied and after drying (e.g., solvent vaporization) dislodges from the vertical surface after about 72 hours of application. In other embodiments, less than about 15%, less than about 5% or less than about 1% by weight of the pesticide composition after being applied and after drying dislodges from the vertical surface after about 72 hours of application. In some particular embodiments, the pesticide composition is capable of adhering to a vertical surface such that substantially none of the pesticide composition after being applied and after drying dislodges from the vertical surface after about 72 hours of application.

While compositions, applicators and methods of embodiments of the present disclosure are generally described with reference to fipronil or other pesticides, it should be understood that these embodiments may optionally include other pesticides in combination or in place of these compounds.

Generally, the ready-to-use pesticide compositions, pesticide applicators and methods for controlling pests of embodiments of the present disclosure are suitable for treatment and control of pest populations generally. In one embodiment, the pest is an arthropod and, in another embodiment, is an insect. The target pest may be selected from the group consisting of termites, ants, cockroaches, beetles, earwigs, silverfish, crickets, spiders, centipedes, millipedes, scorpions, pillbugs, sowbugs, flies, mosquitoes, gnats, moths, wasps, hornets, bees, and the like. In one embodiment, the pest is a termite.

### Examples

### Example 1

### Preparation of a Pesticide Composition that Includes Fipronil and Fumed Silica as an Anti-Caking Agent

Acetone (894.11 g) was added to a vessel and fipronil (3.11 g with about 88.75% active fipronil; BASF (Germany)) was dissolved into the acetone. Microcrystalline cellulose (551.57 g; LATTICE® NT-20; FMC Corp. (Philadelphia, Pa.)) with an average nominal diameter of about 20 μm was sifted in with fumed silica (4.60 g; AEROSIL® 200; Evonik Industries (Germany)) with high mixing.

The mixture was added to a DOT 2Q quality container (6 fl. oz. (177 ml)). The container included an exhaust valve and was activated by an actuator. The container exhausted into a rigid tube. Dimethyl ether propellant was added (26.2 g) and carbon dioxide propellant (10.5 g) was also added. The composition appeared as a dry powder residual after it was applied.

The relative proportions of all ingredients are shown in Table 1 below.

TABLE 1
Relative proportions of ingredients used to prepare
the pesticide composition of Example 1.

| Component | Inclusion (wt %) |
|---|---|
| Fipronil | 0.1690 (0.1500 active) |
| Microcrystalline Cellulose | 30.0000 |
| Fumed Silica | 0.2500 |
| Acetone | 48.6310 |
| Carbon Dioxide | 6.0000 |
| Dimethyl Ether | 14.9500 |

### Example 2

### Preparation of a Pesticide Composition the Includes Fipronil and a Bentonite Clay as a Thickening Agent

A mixture of isoparaffins (291.09 g; Exxon Mobil Corporation (Irving, Tex.)) was added to a vessel and bentonite clay (14.60 g; BENTONE® 38; Elementis Specialties (Hightstown, N.J.)) was mixed in by use of a high sheer mixer. Acetone (266.63 g) was added to another vessel and technical grade fipronil (1.10 g with about 88.75% active fipronil; BASF (Germany)) was dissolved into the acetone. The acetone and fipronil mixture was added to the isoparaffin and bentonite mixture under high sheer mixing. Microcrystalline cellulose (194.71 g; LATTICE® NT-20; FMC Corp. (Philadelphia, Pa.)) with an average nominal diameter of about 20 μm was mixed in until the mixture was uniform.

The mixture was added to a DOT 2Q quality container (8 fl. oz. (237 ml)). The container included an exhaust valve and was activated by an actuator. The container exhausted into a rigid tube. Difluoroethane propellant (140.4 g; HFC-152a; Diversified CPC ((Channahon, Ill.) was added to the container. The composition appeared as a dry powder residual after it was applied.

The relative proportions of all ingredients are shown in Table 2 below.

TABLE 2
Relative proportions of ingredients used to prepare
the pesticide composition of Example 2.

| Component | Inclusion (wt %) |
|---|---|
| Fipronil | 0.0563 (0.0500 active) |
| Microcrystalline Cellulose | 60.5500 |
| Bentonite Clay | 0.7500 |
| Isoparaffins | 14.9500 |
| Acetone | 13.6937 |
| Difluoroethane | 60.5500 |

During storage testing, the composition of Example 2 was more resistant to caking upon storage than the composition of Example 1.

### Example 3

### Determination of the Insecticidal Efficacy of a Dry Pesticide Composition that Includes Fipronil and Microcrystalline Cellulose Against Termites

A first pressurized pesticide composition containing fipronil and microcrystalline cellulose was prepared according to the method of Example 2; however, the first fipronil composition contained 0.005 wt% active instead of 0.05 wt % active. A second composition was prepared according to Example 2 (0.05 wt % fipronil). A control composition containing no fipronil was also prepared.

Each composition was applied from its container to a Petri dish three times. Generally, the composition was dry to the touch after application and did not contain appreciable amounts of solvent. The Petri dish was weighed before and after application to determine the amount of material applied. The amount of pesticide composition applied to each Petri dish and the average from each composition are shown in Table 3 below.

TABLE 3
Amount of pesticide composition applied to sample
Petri dishes for testing purposes.

| | | Average |
|---|---|---|
| | Amount discharged | discharge |
| Treatment | in 1 sec (g) | rate (g/sec) |
| First Composition | 0.09 | 0.14 |
| (0.005 wt % fipronil) | 0.17 | |
| | 0.15 | |
| Second Composition | 0.18 | 0.14 |
| (0.05 wt % fipronil) | 0.12 | |
| | 0.13 | |
| Control (No | 0.16 | 0.19 |
| Fipronil) | 0.29 | |
| | 0.12 | |

To test the repellency/attractiveness of the compositions, 40 eastern subterranean termites (Reticulitermes sp.) were added to two connected Petri dishes (100 mm diameter, 20 mm tall) with a filter paper substrate. One Petri dish contained the pesticidal formulation as applied and the other contained no material. Termites were also added to two connected Petri dishes that did not any pesticide (“Untreated Control”). This was repeated four times for each composition and for the control. The termites were added to the Petri dishes 48 hours after the pesticide compositions were applied.

TABLE 4
Repellency and mortality results for termites introduced into
a double Petri dish containing various pesticide compositions.

| | Time | Mean % occurrence of termites in dishes | | |
|---|---|---|---|---|
| | post | and mean % mortality | | |
| Treatment | exposure | Treated | Untreated | Mortality |
| First | 2 h | 0.0 | 100.0 | — |
| Composition | 4 h | 0.0 | 100.0 | — |
| (0.005 wt % | 1 d | 0.0 | 100.0 | 5.0 |
| fipronil) | 2 d | 26.3 | 73.8 | 8.8 |
| | 3 d | 0.6 | 99.4 | 11.3 |
| | 5 d | 3.1 | 96.9 | 37.5 |
| | 7 d | — | — | 78.1 |
| | 10 d | — | — | 100.0 |
| Second | 2 h | 0.0 | 100.0 | — |
| Composition | 4 h | 0.0 | 100.0 | — |
| (0.05 wt % | 1 d | 8.8 | 91.3 | 10.0 |
| fipronil) | 2 d | 8.8 | 91.3 | 21.3 |
| | 3 d | 7.5 | 92.5 | 42.5 |
| | 5 d | 25.0 | 75.0 | 81.9 |
| | 7 d | — | — | 85.0 |
| | 10 d | — | — | 100.0 |
| Control (No | 2 h | 0.0 | 100.0 | — |
| Fipronil) | 4 h | 2.5 | 97.5 | — |
| | 1 d | 6.3 | 93.8 | 0.6 |
| | 2 d | 12.5 | 87.5 | 0.6 |
| | 3 d | 26.7 | 73.3 | 0.6 |
| | 5 d | 25.0 | 75.0 | 0.6 |
| | 7 d | — | — | 0.6 |
| | 10 d | — | — | 3.8 |
| Untreated | | Side 1^{†} | Side 2 | — |
| Control | 2 h | 22.5 | 77.5 | — |
| | 4 h | 19.4 | 80.6 | — |
| | 1 d | 34.8 | 65.2 | 2.5 |
| | 2 d | 39.0 | 61.0 | 2.5 |
| | 3 d | 38.4 | 61.6 | 2.5 |
| | 5 d | 3.6 | 96.4 | 3.8 |
| | 7 d | — | — | 4.4 |
| | 10 d | — | — | 4.4 |

^{†}Termites were introduced into Side 1 of the Double Petri Dishes

As can be seen from Table 4, the fipronil compositions resulted in significantly greater mortality than the control and the untreated control.

In another test, termites were exposed to the pesticide compositions to determine the response and the ability of the termites to remain alive for a period of time after exposure thereby allowing the termite composition to be transported by the termite (i.e., “donor” termite) to the termite colony. The first and second pesticide compositions and the control composition were applied to Petri dishes (100 mm diameter, 20 mm tall) having a filter paper substrate therein. The compositions where applied for one second. Ten (10) eastern subterranean termites (Reticulitermes sp.) were added 48 hours after the compositions were applied. Termite death (“D”) and intoxication (“I”) were determined after 1.5 hours, 3.5 hours, 5.5 hours and 24 hours.

TABLE 5
Death and intoxication of donor termite populations after
exposure to various pesticide compositions.

| | | Termite mortality/intoxication at time | | | | | | | |
|---|---|---|---|---|---|---|---|---|---|
| | Exposure | after exposure | | | | | | | |
| | time | 1.5 h | | 3.5 h | | 5.5 h | | 24 h | |
| Treatment | (min) | D | I | D | I | D | I | D | I |
| First | 1 | 0 | 0 | 0 | 0 | 0 | 0 | 4 | 6 |
| Composition | 5 | 0 | 0 | 0 | 0 | 0 | 0 | 4 | 6 |
| (0.005 wt % | 7 | 0 | 0 | 0 | 0 | 0 | 0 | 8 | 2 |
| fipronil) | 10 | 1 | 0 | 1 | 0 | 1 | 0 | 10 | 0 |
| Second | 1 | 0 | 0 | 0 | 0 | 0 | 0 | 10 | 0 |
| Composition | 5 | 2 | 0 | 2 | 2 | 6 | 4 | 10 | 0 |
| (0.05 wt % | 7 | 0 | 0 | 5 | 0 | 8 | 2 | 10 | 0 |
| fipronil) | 10 | 3 | 3 | 8 | 2 | 10 | 0 | 10 | 0 |
| Control (No | 10 | 1 | 0 | 1 | 0 | 1 | 0 | 1 | 0 |
| Fipronil) | | | | | | | | | |

As can be seen from Table 5, a significant number of termites were alive and mobile for up to 5 hours which allows the termites sufficient time to travel to the termite colony and expose the colony to the pesticide.

In another test, donor termites were prepared by exposing the termites to the first pesticide composition (0.005 wt % fipronil) or the second pesticide composition (0.05 wt % fipronil) for 5 hours in a Petri dish. The pesticide compositions were applied from the respective containers for one second and 48 hours passed before the donors were added to the dish. Donors were died blue for marking. Donor termites were added to populations of non-donor termites in donor:non-donor ratios of 2:38, 10:30, 20:20, 30:10 and 40:0 (40 total termites per dish). The termites (donor and non-donor) were added to Petri dishes (100 mm diameter; 20 mm tall with 40 termites per dish) with a filter paper substrate. Each test was replicated four times. The results of pesticide exposure is shown in Table 6 below.

TABLE 6
Time until 100%
mortality in donor and non-donor populations at various ratios.

| | Ratio | Time (days) to 100% mortality | |
|---|---|---|---|
| Treatment | (Donor:Non-Donor) | Donors | Non-donor |
| First | 2:38 | 5 | >21 |
| Composition | 10:30 | 10 | 10 |
| (0.005 wt % | 20:20 | 10 | 21^{†} |
| fipronil) | 30:10 | 5 | 5 |
| | 40:0 | 5 | — |
| Second | 2:38 | 5 | 21 |
| Composition | 10:30 | 5 | 5 |
| (0.05 wt % | 20:20 | 3 | 3 |
| fipronil) | 30:10 | 3 | 3 |
| | 40:0 | 1 | — |

^{†}All but one replicate achieved 100% mortality by 10 d; next evaluation was 21 d.

As can be seen from Table 6, donor termites caused 100% mortality even at relatively low donor:non-donor ratios.

### Example 4

### Comparison of an Aerosol Dry Pesticide Composition Against Commercial Foam Formulations in Controlling Termites

A first fipronil pesticide composition as described in Example 1 was prepared. A second fipronil composition having less fipronil as shown in Table 7 was also prepared.

TABLE 7
Relative proportions of ingredients used to prepare the second fipronil
pesticide composition.

| Component | Inclusion (wt %) |
|---|---|
| Fipronil | 0.001 (0.0009 active) |
| Microcrystalline Cellulose | 30.0000 |
| Fumed Silica | 0.2500 |
| Acetone | 48.7831 |
| Carbon Dioxide | 6.0000 |
| Dimethyl Ether | 14.9500 |

Termite populations were exposed to the first and second pesticide compositions as well as several commercially available foam compositions to determine efficacy of control. The commercial foam compositions were ALPINE® Ant and Termite Foam (BASF; Germany), FASTOUT® CS Foam (BASF; Germany) and PREMISE® Foam (Bayer Environmental Science; Research Triangle Park, N.C.). A control was also tested. ALPINE® Ant and Termite Control contains dinotefuran as the active. FASTOUT® CS Foam contains microencapsulated cyfluthrin as the active. PREMISE® Foam contains imidacloprid as the pesticide active.

The pesticide compositions were applied to Petri dishes (150 mm diameter; 25 mm tall). Two hundred (200) worker termites (3^{rd} instar larva stage or older) were added to each respective Petri dish. Each trial was replicated six times for two species of termite: Eastern subterranean termites (Reticulitermes flavipes) and Formosan subterranean termites (Coptotermes formosanus). Mean mortalities were analyzed by ANOVA with means being separated using the Student-Newman-Keuls test at P<0.05. The mortality results are shown in Tables 8 and 9.

TABLE 8
Mortality of termites (C. formosanus) when exposed to various pesticide
compositions.

| Treatment | 1 hour | 4 hours | 8 hours | 24 hours | 48 hours | 72 hours |
|---|---|---|---|---|---|---|
| First Fipronil Composition | 194.00 | 200.00 | 200.00 | 200.00 | 200.00 | 200.00 |
| Second Fipronil Composition | 1.16 | 2.00 | 110.50 | 200.00 | 200.00 | 200.00 |
| ALPINE ® Foam | 2.16 | 3.16 | 3.83 | 15.00 | 32.66 | 70.33 |
| FASTOUT ® Foam | 190.0 | 200.00 | 200.00 | 200.00 | 200.00 | 200.00 |
| PREMISE ® Foam | 2.50 | 6.00 | 6.00 | 7.66 | 29.66 | 125.00 |
| Untreated Control | 0.50 | 1.33 | 2.50 | 2.83 | 3.33 | 2.00 |

TABLE 9
Mortality of termites (R. flavipes) when exposed to various pesticide
compositions.

| Treatment | 1 hour | 4 hours | 8 hours | 24 hours | 48 hours | 72 hours |
|---|---|---|---|---|---|---|
| First Fipronil Composition | 196.66 | 200.00 | 200.00 | 200.00 | 200.00 | 200.00 |
| Second Fipronil Composition | 0.83 | 2.83 | 40.66 | 200.00 | 200.00 | 200.00 |
| ALPINE ® Foam | 0.16 | 0.16 | 1.50 | 19.50 | 147.83 | 183.66 |
| FASTOUT ® Foam | 198.00 | 200.00 | 200.00 | 200.00 | 200.00 | 200.00 |
| PREMISE ® Foam | 2.50 | 6.00 | 6.00 | 7.66 | 29.66 | 158.00 |
| Untreated Control | 0.83 | 1.00 | 1.33 | 1.83 | 1.83 | 2.16 |

As can be seen from Tables 8 and 9, the dry aerosol pesticide compositions of embodiments of the present disclosure are effective as or even more effective than commercial foam formulations.

### Example 5

### Determination of the Adhesive Properties of Pesticide Compositions of the Present Disclosure

Several surfaces were treated with the pesticide composition of Example 2. Each surface was treated in the vertical position with a two (2) second spray of the pressurized composition through a plastic tube about 4 inches (10.16 cm) long with about 8 inches (20.32 cm) between the tip of the tube to the treated surface. The rate of application of the composition was 1.25 g/sec which resulted in application of 2.5 g/surface. After treatment, each surface was repositioned in is vertical position above collection papers. After the specified time intervals, each of the collection papers was weighed and the amount of pesticide composition dislodged from the vertical surface that fell to the collection paper was determined. The results are shown in Table 10 below.

TABLE 10
Pesticide material that dislodged during vertical wall testing.

| | Concrete | | | Linoleum | Paper |
|---|---|---|---|---|---|
| | block, not | Tile | Tile | tile | (similar to |
| | finished | (glazed) | (unglazed) | (unfinished | drywall |
| Time (h) | surface (g) | (g) | (g) | surface) (g) | paper) (g) |
| 1 | 0 | 0 | 0 | 0 | 0 |
| 24 | 0 | 0 | 0 | 0 | 0 |
| 48 | 0 | 0 | 0 | 0 | 0 |
| 72 | 0 | 0 | 0 | 0 | 0 |

As can be seen from Table 9, substantially all of the pesticide composition (after drying and vaporization of all solvent) remained adhered to the vertical surface for at least about 72 hours.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above apparatus and methods without departing from the scope of the invention, it is intended that all matter contained in the above description and shown in the accompanying figures shall be interpreted as illustrative and not in a limiting sense.

What is claimed is:

1. A ready-to-use pesticide composition comprising a solvent, a pesticide dissolved in the solvent, a particulate attractant suspended in the solvent and a thickening agent.

2. A ready-to-use pesticide composition as set forth in claim 1 comprising a co-solvent.

3. A ready-to-use pesticide composition as set forth in claim 2 wherein the thickening agent is functional in the co-solvent.

4. A ready-to-use pesticide composition as set forth in claim 3 wherein the thickening agent is not functional in the solvent alone.

5. A ready-to-use pesticide composition as set forth in claim 4 wherein the attractant comprises cellulose.

6. A ready-to-use pesticide composition as set forth in claim 5 wherein the cellulose is selected from the group consisting of microcrystalline cellulose, purified cellulose and α-cellulose.

7. A ready-to-use pesticide composition as set forth in claim 5 wherein the cellulose is micro-crystalline cellulose.

8. A ready-to-use pesticide composition as set forth in claim 1 wherein the pesticide is selected from the group consisting of (M1) organo(thio)phosphate compounds, (M2) carbamate compounds, (M3) pyrethroid compounds, (M4) juvenile hormone mimics, (M5) nicotinic receptor agonists/antagonists compounds, (M6) GABA gated chloride channel antagonist compounds, (M7) chloride channel activators, (M8) METI I compounds, (M9) METI II and III compounds, (M10) uncouplers of oxidative phosphorylation, (M11) inhibitors of oxidative phosphorylation; (M12) moulting disruptors, (M14) sodium channel blocker compounds, (M15) selective feeding blockers, (M16) mite growth inhibitors, (M17) chitin synthesis inhibitors, (M18) lipid biosynthesis inhibitors, (M19) octapaminergic agonsits, (M20) ryanodine receptor modulators, (M21) isoxazoline compounds, (M22) anthranilamide compounds, (M23) malononitrile compounds, (M24) microbial disruptors and (M25) aminofuranone compounds.

9. A ready-to-use pesticide composition as set forth in claim 1 wherein the pesticide is selected from the group consisting of (M1) organo(thio)phosphate compounds selected from the group consisting of acephate, azamethiphos, azinphos-ethyl, azinphos-methyl, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, flupyrazophos, fosthiazate, heptenophos, isoxathion, malathion, mecarbam, methamidophos, methidathion, mevinphos, monocrotophos, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon and vamidothion; (M2) carbamate compounds selected from the group consisting of aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb and triazamate; (M3) pyrethroid compounds selected from the group consisting of acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, metofluthrin, permethrin, phenothrin, prallethrin, profluthrin, pyrethrin (pyrethrum), resmethrin, silafluofen, tefluthrin, tetramethrin, tralomethrin and transfluthrin; (M4) juvenile hormone mimics selected from the group consisting of hydroprene, kinoprene, methoprene, fenoxycarb and pyriproxyfen; (M5) nicotinic receptor agonists/antagonists compounds selected from the group consisting of acetamiprid, bensultap, cartap hydrochloride, clothianidin, dinotefuran, imidacloprid, thiamethoxam, nitenpyram, nicotine, spinosad (allosteric agonist), spinetoram (allosteric agonist), thiacloprid, thiocyclam, thiosultap-sodium and AKD1022; (M6) GABA gated chloride channel antagonist compounds selected from the group consisting of chlordane, endosulfan, gamma-HCH (lindane); ethiprole, fipronil, pyrafluprole and pyriprole; (M7) chloride channel activators selected from the group consisting of abamectin, emamectin benzoate, milbemectin and lepimectin; (M8) METI I compounds selected from the group consisting of fenazaquin, fenpyroximate, pyrimidifen, pyridaben, tebufenpyrad, tolfenpyrad, flufenerim and rotenone; (M9) METI II and III compounds selected from the group consisting of acequinocyl, fluacyprim, hydramethylnon; (M10) uncouplers of oxidative phosphorylation selected from the group consisting of chlorfenapyr and DNOC; (M11) inhibitors of oxidative phosphorylation selected from the group consisting of azocyclotin, cyhexatin, diafenthiuron, fenbutatin oxide, propargite, tetradifon; (M12) moulting disruptors selected from the group consisting of cyromazine, chromafenozide, halofenozide, methoxyfenozide, tebufenozide; synergists selected from the group consisting of piperonyl butoxideand tribufos; (M14) sodium channel blocker compounds selected from the group consisting of indoxacarb, metaflumizone; (M15) selective feeding blockers selected from the group consisting of crylotie, pymetrozine and flonicamid; (M16) mite growth inhibitors selected from the group consisting of clofentezine, hexythiazox and etoxazole; (M17) chitin synthesis inhibitors selected from the group consisting of buprofezin, bistrifluron, chlorfluazuron, diflubenzuron, flucycloxuron, flufenoxuron, hexaflumuron, lufenuron, novaluron, noviflumuron, teflubenzuron and triflumuron; (M18) lipid biosynthesis inhibitors selected from the group consisting of spirodiclofen, spiromesifen, spirotetramat; (M19) octapaminergic agonsits selected from amitraz; (M20) ryanodine receptor modulators selected from the group consisting of flubendiamide and the phtalamid compound (R)-, (S)-3-Chlor-N1-{2-methyl-4-[1,2,2,2-tetrafluor-1-(trifluormethyl)ethyl]phenyl}-N2-(1-methyl-2-methylsulfonylethyl)phthalamid (M20.1); (M21) isoxazoline compounds selected from the group consisting of 4-[5-(3,5-Dichloro-phenyl)-5-trifluoromethyl-4,5-dihydro-isoxazol-3-yl]-2-methyl-N-pyridin-2-ylmethyl-benzamide (M21.1), 4-[5-(3,5-Dichloro-phenyl)-5-trifluoromethyl-4,5-dihydro-isoxazol-3-yl]-2-methyl-N-(2,2,2-trifluoro-ethyl)-benzamide (M21.2), 4-[5-(3,5-Dichloro-phenyl)-5-trifluoromethyl-4,5-dihydro-isoxazol-3-yl]-2-methyl-N-[(2,2,2-trifluoro-ethylcarbamoyl)-methyl]-benzamide (M21.3), 4-[5-(3,5-Dichloro-phenyl)-5-trifluoromethyl-4,5-dihydro-isoxazol-3-yl]-naphthalene-1-carboxylic acid [(2,2,2-trifluoro-ethylcarbamoyl)-methyl]-amide (M21.4), 4-[5-(3,5-Dichlorophenyl)-5-trifluoromethyl-4,5-dihydro-isoxazol-3-yl]-N-[(methoxyimino)methyl]-2-methylbenzamide (M21.5) 4-[5-(3-Chloro-5-trifluoromethyl-phenyl)-5-trifluoromethyl-4,5-dihydro-isoxazol-3-yl]-2-methyl-N-[(2,2,2-trifluoro-ethylcarbamoyl)-methyl]-benzamide (M21.6), 4-[5-(3-Chloro-5-trifluoromethyl-phenyl)-5-trifluoromethyl-4,5-dihydro-isoxazol-3-yl]-naphthalene-1-carboxylic acid [(2,2,2-trifluoro-ethylcarbamoyl)-methyl]-amide (M21.7) and 5-[5-(3,5-Dichloro-4-fluoro-phenyl)-5-trifluoromethyl-4,5-dihydro-isoxazol-3-yl]-2-[1,2,4]triazol-1-yl-benzonitrile (M21.8); (M22) anthranilamide compounds selected from the group consisting of chloranthraniliprole, cyantraniliprole, 5-Bromo-2-(3-chloro-pyridin-2-yl)-2H-pyrazole-3-carboxylic acid [4-cyano-2-(1-cyclopropyl-ethylcarbamoyl)-6-methyl-phenyl]-amide (M22.1), 5-Bromo-2-(3-chloro-pyridin-2-yl)-2H-pyrazole-3-carboxylic acid [2-chloro-4-cyano-6-(1-cyclopropyl-ethylcarbamoyl)-phenyl]-amide (M22.2), 5-Bromo-2-(3-chloro-pyridin-2-yl)-2H-pyrazole-3-carboxylic acid [2-bromo-4-cyano-6-(1-cyclopropyl-ethylcarbamoyl)-phenyl]-amide (M22.3), 5-Bromo-2-(3-chloro-pyridin-2-yl)-2H-pyrazole-3-carboxylic acid [2-bromo-4-chloro-6-(1-cyclopropyl-ethylcarbamoyl)-phenyl]-amide (M22.4), 5-Bromo-2-(3-chloro-pyridin-2-yl)-2H-pyrazole-3-carboxylic acid [2,4-dichloro-6-(1-cyclopropyl-ethylcarbamoyl)-phenyl]-amide (M22.5), 5-Bromo-2-(3-chloro-pyridin-2-yl)-2H-pyrazole-3-carboxylic acid [4-chloro-2-(1-cyclopropyl-ethylcarbamoyl)-6-methyl-phenyl]-amide (M22.6), N′-(2-{[5-Bromo-2-(3-chloro-pyridin-2-yl)-2H-pyrazole-3-carbonyl]-amino}-5-chloro-3-methyl-benzoyl)-hydrazinecarboxylic acid methyl ester (M22.7), N′-(2-{[5-Bromo-2-(3-chloro-pyridin-2-yl)-2H-pyrazole-3-carbonyl]-amino}-5-chloro-3-methyl-benzoyl)-N′-methyl-hydrazinecarboxylic acid methyl ester (M22.8), N′-(2-{[5-Bromo-2-(3-chloro-pyridin-2-yl)-2H-pyrazole-3-carbonyl]-amino}-5-chloro-3-methyl-benzoyl)-N,N′-dimethyl-hydrazinecarboxylic acid methyl ester (M22.9), N′-(3,5-Dibromo-2-{[5-bromo-2-(3-chloro-pyridin-2-yl)-2H-pyrazole-3-carbonyl]-amino}-benzoyl)-hydrazinecarboxylic acid methyl ester (M22.10), N′-(3,5-Dibromo-2-{[5-bromo-2-(3-chloro-pyridin-2-yl)-2H-pyrazole-3-carbonyl]-amino}-benzoyl)-N′-methyl-hydrazinecarboxylic acid methyl ester (M22.11) and N′-(3,5-Dibromo-2-{[5-bromo-2-(3-chloro-pyridin-2-yl)-2H-pyrazole-3-carbonyl]-amino}-benzoyl)-N,N′-dimethyl-hydrazinecarboxylic acid methyl ester (M22.12); (M23) malononitrile compounds selected from the group consisting of 2-(2,2,3,3,4,4,5,5-octafluoropentyl)-2-(3,3,3-trifluoro-propyl)malononitrile (CF2H—CF2-CF2-CF2-CH2-C(CN)2-CH2-CH2-CF3) (M23.1) and 2-(2,2,3,3,4,4,5,5-octafluoropentyl)-2-(3,3,4,4,4-pentafluorobutyl)-malonodinitrile (CF2H—CF2-CF2-CF2-CH2-C(CN)2-CH2-CH2-CF2-CF3) (M23.2); (M24) microbial disruptors selected from the group consisting of Bacillus thuringiensis subsp. Israelensi, Bacillus sphaericus, Bacillus thuringiensis subsp. Aizawai, Bacillus thuringiensis subsp. Kurstaki and Bacillus thuringiensis subsp. Tenebrionis; (M25) aminofuranone compounds selected from the group consisting of 4-{[(6-Bromopyrid-3-yl)methyl](2-fluoroethyl)amino}furan-2(5H)-on (M25.1), 4-{[(6-Fluoropyrid-3-yl)methyl](2,2-difluoroethyl)amino}furan-2(5H)-on (M25.2), 4-{[(2-Chloro1,3-thiazolo-5-yl)methyl](2-fluoroethyl)amino}furan-2(5H)-on (M25.3), 4-{[(6-Chloropyrid-3-yl)methyl](2-fluoroethyl)amino}furan-2(5H)-on (M25.4), 4-{[(6-Chloropyrid-3-yl)methyl](2,2-difluoroethyl)amino}furan-2(5H)-on (M25.5), 4-{[(6-Chloro-5-fluoropyrid-3-yl)methyl](methyl)amino}furan-2(5H)-on (M25.6), 4-{[(5,6-Dichloropyrid-3-yl)methyl](2-fluoroethyl)amino}furan-2(5H)-on (M25.7), 4-{[(6-Chloro-5-fluoropyrid-3-yl)methyl](cyclopropyl)amino}furan-2(5H)-on (M25.8), 4-{[(6-Chloropyrid-3-yl)methyl](cyclopropyl)amino}furan-2(5H)-on (M25.9) and 4-{[(6-Chloropyrid-3-yl)methyl](methyl)amino}furan-2(5H)-on (M25.10); (M26) various other compounds selected from the group consisting of amidoflumet, benclothiaz, benzoximate, bifenazate, borax, bromopropylate, cyenopyrafen, cyflumetofen, chinomethionate, dicofol, fluoroacetate, pyridalyl, pyrifluquinazon, tartar emetic, sulfoxaflor, N—R′-2,2-dihalo-1-R″cyclo-propanecarboxamide-2-(2,6-dichloro-α,α,α-trifluoro-p-tolyl)hydrazone or N—R′-2,2-di(R′″)propionamide-2-(2,6-dichloro-α,α,α-trifluoro-p-tolyl)-hydrazone, wherein R′ is methyl or ethyl, halo is chloro or bromo, R″ is hydrogen or methyl and R′″ is methyl or ethyl, 4-But-2-ynyloxy-6-(3,5-dimethyl-piperidin-1-yl)-2-fluoro-pyrimidine (M26.1), Cyclopropaneacetic acid, 1,1′-[(3S,4R,4aR,6S,6aS,12R,12aS,12bS)-4-[[(2-cyclopropylacetyl)oxy]methyl]-1,3,4,4a,5,6,6a,12,12a,12b-decahydro-12-hydroxy-4,6a,12b-trimethyl-11-oxo-9-(3-pyridinyl)-2H,11H-naphtho[2,1-b]pyrano[3,4-e]pyran-3,6-diyl]ester (M26.2) and 8-(2-Cyclopropylmethoxy-4-trifluoromethyl-phenoxy)-3-(6-trifluoromethyl-pyridazin-3-yl)-3-aza-bicyclo[3.2.1]octane (M26.3).

10. A ready-to-use pesticide composition as set forth in claim 1 wherein the pesticide is fipronil.

11. A ready-to-use pesticide composition as set forth in claim 9 wherein the composition comprises at least about 0.005% by weight fipronil.

12. A ready-to-use pesticide composition as set forth in claim 1 wherein the solvent is chosen from the group consisting of acetone, alcohols, esters, ethers and mixtures thereof.

13. A ready-to-use pesticide composition as set forth in claim 2 wherein the co-solvent is a mixture of isoparaffins.

14. A ready-to-use pesticide composition as set forth in claim 1 wherein the composition comprises at least about 10% by weight solvent.

15. A ready-to-use pesticide composition as set forth in claim 1 wherein the thickening agent is selected from xantham gum, guar gum, gum arabic, alginin, gum tragacanth, sodium alginate and bentonite clay.

16. A ready-to-use pesticide composition as set forth in claim 1 wherein the thickening agent is bentonite clay.

17. A ready-to-use pesticide composition as set forth in claim 1 wherein the composition comprises at least about 0.1% thickening agent by weight.

18. A ready-to-use pesticide composition as set forth in claim 1 wherein the pesticide composition is capable of adhering to a vertical surface in a manner such that less than about 25% by weight of the pesticide composition after being applied and after drying dislodges from the vertical surface after about 72 hours.

19. A ready-to-use pesticide composition as set forth in claim 1 wherein the pesticide composition is capable of adhering to a vertical surface such that substantially none of the pesticide composition after being applied and after drying dislodges from the vertical surface after about 72 hours of application.

20. A ready-to-use pesticide composition as set forth in claim 1, wherein the pesticide composition controls termites, the composition comprising a particulate termite attractant.

21. A ready-to-use pesticide composition as set forth in claim 20, wherein the pesticide composition also controls ants, cockroaches, bees or wasps.

22. A ready-to-use pesticide composition as set forth in claim 20, wherein the pesticide composition also controls ants, cockroaches, bees and wasps.

23. A pesticide applicator for applying pesticide to pests, the applicator comprising:
a container; and
a pesticide composition within the container, the pesticide composition comprising a solvent, a pesticide dissolved in the solvent, a particulate attractant suspended in the solvent and a thickening agent.

24. A pesticide applicator as set forth in claim 23 wherein the pesticide composition is pressurized within the container.

25. A pesticide applicator as set forth in claim 24 wherein the pesticide composition comprises a propellant.

26. A method for controlling pests, the method comprising:
dispensing a pesticide composition comprising a solvent, a pesticide dissolved in the solvent, a particulate attractant suspended in the solvent and a thickening agent, wherein the solvent vaporizes after the composition is dispensed; and
contacting a target surface, space, void or crevice with the pesticide and attractant.

27. A method as set forth in claim 26 wherein pesticide attaches to the particulate attractant upon vaporization of the solvent.

28. A method as set forth in claim 26 wherein the pest is an arthropod.

29. A method as set forth in claim 26 wherein the composition comprises a co-solvent.

30. A method as set forth in claim 29 wherein the thickening agent is functional in the co-solvent.

31. A method as set forth in claim 29 wherein the thickening agent is not functional in the solvent alone.

32. A method as set forth in claim 26 wherein the attractant comprises cellulose selected from the group consisting of microcrystalline cellulose, purified cellulose and α-cellulose.

33. A method as set forth in claim 26 wherein the pesticide is selected from the group consisting of (M1) organo(thio)phosphate compounds, (M2) carbamate compounds, (M3) pyrethroid compounds, (M4) juvenile hormone mimics, (M5) nicotinic receptor agonists/antagonists compounds, (M6) GABA gated chloride channel antagonist compounds, (M7) chloride channel activators, (M8) METI I compounds, (M9) METI II and III compounds, (M10) uncouplers of oxidative phosphorylation, (M11) inhibitors of oxidative phosphorylation; (M12) moulting disruptors, (M14) sodium channel blocker compounds, (M15) selective feeding blockers, (M16) mite growth inhibitors, (M17) chitin synthesis inhibitors, (M18) lipid biosynthesis inhibitors, (M19) octapaminergic agonsits, (M20) ryanodine receptor modulators, (M21) isoxazoline compounds, (M22) anthranilamide compounds, (M23) malononitrile compounds, (M24) microbial disruptors and (M25) aminofuranone compounds.

34. A method as set forth in claim 26 wherein the pesticide is selected from the group consisting of (Ml) organo(thio)phosphate compounds selected from the group consisting of acephate, azamethiphos, azinphos-ethyl, azinphos-methyl, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, flupyrazophos, fosthiazate, heptenophos, isoxathion, malathion, mecarbam, methamidophos, methidathion, mevinphos, monocrotophos, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon and vamidothion; (M2) carbamate compounds selected from the group consisting of aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb and triazamate; (M3) pyrethroid compounds selected from the group consisting of acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, metofluthrin, permethrin, phenothrin, prallethrin, profluthrin, pyrethrin (pyrethrum), resmethrin, silafluofen, tefluthrin, tetramethrin, tralomethrin and transfluthrin; (M4) juvenile hormone mimics selected from the group consisting of hydroprene, kinoprene, methoprene, fenoxycarb and pyriproxyfen; (M5) nicotinic receptor agonists/antagonists compounds selected from the group consisting of acetamiprid, bensultap, cartap hydrochloride, clothianidin, dinotefuran, imidacloprid, thiamethoxam, nitenpyram, nicotine, spinosad (allosteric agonist), spinetoram (allosteric agonist), thiacloprid, thiocyclam, thiosultap-sodium and AKD1022; (M6) GABA gated chloride channel antagonist compounds selected from the group consisting of chlordane, endosulfan, gamma-HCH (lindane); ethiprole, fipronil, pyrafluprole and pyriprole; (M7) chloride channel activators selected from the group consisting of abamectin, emamectin benzoate, milbemectin and lepimectin; (M8) METI I compounds selected from the group consisting of fenazaquin, fenpyroximate, pyrimidifen, pyridaben, tebufenpyrad, tolfenpyrad, flufenerim and rotenone; (M9) METI II and III compounds selected from the group consisting of acequinocyl, fluacyprim, hydramethylnon; (M10) uncouplers of oxidative phosphorylation selected from the group consisting of chlorfenapyr and DNOC; (M11) inhibitors of oxidative phosphorylation selected from the group consisting of azocyclotin, cyhexatin, diafenthiuron, fenbutatin oxide, propargite, tetradifon; (M12) moulting disruptors selected from the group consisting of cyromazine, chromafenozide, halofenozide, methoxyfenozide, tebufenozide; synergists selected from the group consisting of piperonyl butoxideand tribufos; (M14) sodium channel blocker compounds selected from the group consisting of indoxacarb, metaflumizone; (M15) selective feeding blockers selected from the group consisting of crylotie, pymetrozine and flonicamid; (M16) mite growth inhibitors selected from the group consisting of clofentezine, hexythiazox and etoxazole; (M17) chitin synthesis inhibitors selected from the group consisting of buprofezin, bistrifluron, chlorfluazuron, diflubenzuron, flucycloxuron, flufenoxuron, hexaflumuron, lufenuron, novaluron, noviflumuron, teflubenzuron and triflumuron; (M18) lipid biosynthesis inhibitors selected from the group consisting of spirodiclofen, spiromesifen, spirotetramat; (M19) octapaminergic agonsits selected from amitraz; (M20) ryanodine receptor modulators selected from the group consisting of flubendiamide and the phtalamid compound (R)-, (S)-3- Chlor-N1-{2-methyl-4-[1,2,2,2-tetrafluor-1-(trifluormethyl)ethyl]phenyl}-N2-(1-methyl-2-methylsulfonylethyl)phthalamid (M20.1); (M21) isoxazoline compounds selected from the group consisting of 4-[5-(3,5-Dichloro-phenyl)-5-trifluoromethyl-4,5-dihydro-isoxazol-3-yl]-2-methyl-N-pyridin-2-ylmethyl-benzamide (M21.1), 4-[5-(3,5-Dichloro-phenyl)-5-trifluoromethyl-4,5-dihydro-isoxazol-3-yl]-2-methyl-N-(2,2,2-trifluoro-ethyl)-benzamide (M21.2), 4-[5-(3,5-Dichloro-phenyl)-5-trifluoromethyl-4,5-dihydro-isoxazol-3-yl]-2-methyl-N-[(2,2,2-trifluoro-ethylcarbamoyl)-methyl]-benzamide (M21.3), 4-[5-(3,5-Dichloro-phenyl)-5-trifluoromethyl-4,5-dihydro-isoxazol-3-yl]-naphthalene-1-carboxylic acid [(2,2,2-trifluoro-ethylcarbamoyl)-methyl]-amide (M21.4), 4-8 5-(3,5-Dichlorophenyl)-5-trifluoromethyl-4,5-dihydro-isoxazol-3-ul]-N-[(methoxyimino)methyl]-2-methylbenzamide (M21.5) 4-[5-(3-Chloro-5-trifluoromethyl-phenyl)-5-trifluoromethyl-4,5-dihydro-isoxazol-3-yl]-2-methyl-N-[(2,2,2-trifluoro-ethylcarbamoyl)-methyl]-benzamide (M21.6), 4-[5-(3-Chloro-5-trifluoromethyl-phenyl)-5-trifluoromethyl-4,5-dihydro-isoxazol-3-yl]-naphthalene-1-carboxylic acid [(2,2,2-trifluoro-ethylcarbamoyl)-methyl]-amide (M21.7) and 5-[5-(3,5-Dichloro-4-fluoro-phenyl)-5-trifluoromethyl-4,5-dihydro-isoxazol-3-yl]-2-[1,2,4]triazol-1-yl-benzonitrile (M21.8); (M22) anthranilamide compounds selected from the group consisting of chloranthraniliprole, cyantraniliprole, 5-Bromo-2-(3-chloro-pyridin-2-yl)-2H-pyrazole-3-carboxylic acid [4-cyano-2-(1-cyclopropyl-ethylcarbamoyl)-6-methyl-phenyl]-amide (M22.1), 5-Bromo-2-(3-chloro-pyridin-2-yl)-2H-pyrazole-3-carboxylic acid [2-chloro-4-cyano-6-(1-cyclopropyl-ethylcarbamoyl)-phenyl]-amide (M22.2), 5-Bromo-2-(3-chloro-pyridin-2-yl)-2H-pyrazole-3-carboxylic acid [2-bromo-4-cyano-6-(1-cyclopropyl-ethylcarbamoyl)-phenyl]-amide (M22.3), 5-Bromo-2-(3-chloro-pyridin-2-yl)-2H-pyrazole-3-carboxylic acid [2-bromo-4-chloro-6-(1-cyclopropyl-ethylcarbamoyl)-phenyl]-amide (M22.4), 5-Bromo-2-(3-chloro-pyridin-2-yl)-2H-pyrazole-3-carboxylic acid [2,4-dichloro-6-(1-cyclopropyl-ethylcarbamoyl)-phenyl]-amide (M22.5), 5-Bromo-2-(3-chloro-pyridin-2-yl)-2H-pyrazole-3-carboxylic acid [4-chloro-2-(1-cyclopropyl-ethylcarbamoyl)-6-methyl-phenyl]-amide (M22.6), N′-(2-{[5-Bromo-2-(3-chloro-pyridin-2-yl)-2H-pyrazole-3-carbonyl]-amino}-5-chloro-3-methyl-benzoyl)-hydrazinecarboxylic acid methyl ester (M22.7), N′-(2-{[5-Bromo-2-(3-chloro-pyridin-2-yl)-2H-pyrazole-3-carbonyl]-amino}-5-chloro-3-methyl-benzoyl)-N′-methyl-hydrazinecarboxylic acid methyl ester (M22.8), N′-(2-{[5-Bromo-2-(3-chloro-pyridin-2-yl)-2H-pyrazole-3-carbonyl]-amino}-5-chloro-3-methyl-benzoyl)-N,N′-dimethyl-hydrazinecarboxylic acid methyl ester (M22.9), N′-(3,5-Dibromo-2-{[5-bromo-2-(3-chloro-pyridin-2-yl)-2H-pyrazole-3-carbonyl]-amino}-benzoyl)-hydrazinecarboxylic acid methyl ester (M22.10), N′-(3,5-Dibromo-2-{[5-bromo-2-(3-chloro-pyridin-2-yl)-2H-pyrazole-3-carbonyl]-amino}-benzoyl)-N′-methyl-hydrazinecarboxylic acid methyl ester (M22.11) and N′-(3,5-Dibromo-2-{[5-bromo-2-(3-chloro-pyridin-2-yl)-2H-pyrazole-3-carbonyl]-amino}-benzoyl)-N,N′-dimethyl-hydrazinecarboxylic acid methyl ester (M22.12); (M23) malononitrile compounds selected from the group consisting of 2-(2,2,3,3,4,4,5,5-octafluoropentyl)-2-(3,3,3-trifluoro-propyl)malononitrile (CF2H—CF2-CF2-CF2-CH2-C(CN)2-CH2-CH2-CF3) (M23.1) and 2-(2,2,3,3,4,4,5,5-octafluoropentyl)-2-(3,3,4,4,4-pentafluorobutyl)-malonodinitrile (CF2H—CF2-CF2-CF2-CH2-C(CN)2-CH2-CH2-CF2-CF3) (M23.2); (M24) microbial disruptors selected from the group consisting of Bacillus thuringiensis subsp. Israelensi, Bacillus sphaericus, Bacillus thuringiensis subsp. Aizawai, Bacillus thuringiensis subsp. Kurstaki and Bacillus thuringiensis subsp. Tenebrionis; (M25) aminofuranone compounds selected from the group consisting of 4-{[(6-Bromopyrid-3-yl)methyl](2-fluoroethyl)amino}furan-2(5H)-on (M25.1), 4-{[(6-Fluoropyrid-3-yl)methyl](2,2-difluoroethyl)amino}furan-2(5H)-on (M25.2), 4-{[(2-Chloro1,3-thiazolo-5-yl)methyl](2-fluoroethyl)amino}furan-2(5H)-on (M25.3), 4-{[(6-Chloropyrid-3-yl)methyl](2-fluoroethyl)amino}furan-2(5H)-on (M25.4), 4-{[(6-Chloropyrid-3-yl)methyl](2,2-difluoroethyl)amino}furan-2(5H)-on (M25.5), 4-{[(6-Chloro-5-fluoropyrid-3-yl)methyl](methyl)amino}furan-2(5H)-on (M25.6), 4-{[(5,6-Dichloropyrid-3-yl)methyl](2-fluoroethyl)amino}furan-2(5H)-on (M25.7), 4-{[(6-Chloro-5-fluoropyrid-3-yl)methyl](cyclopropyl)amino}furan-2(5H)-on (M25.8), 4-{[(6-Chloropyrid-3-yl)methyl](cyclopropyl)amino}furan-2(5H)-on (M25.9) and 4-{[(6-Chloropyrid-3-yl)methyl](methyl)amino}furan-2(5H)-on (M25.10); (M26) various other compounds selected from the group consisting of amidoflumet, benclothiaz, benzoximate, bifenazate, borax, bromopropylate, cyenopyrafen, cyflumetofen, chinomethionate, dicofol, fluoroacetate, pyridalyl, pyrifluquinazon, tartar emetic, sulfoxaflor, N—R′-2,2-dihalo-1-R″cyclo-propanecarboxamide-2-(2,6-dichloro-α,α,α-trifluoro-p-tolyl)hydrazone or N—R′-2,2-di(R′″)propionamide-2-(2,6-dichloro-α,α,α-trifluoro-p-tolyl)-hydrazone, wherein R′ is methyl or ethyl, halo is chloro or bromo, R″ is hydrogen or methyl and R′″ is methyl or ethyl, 4-But-2-ynyloxy-6-(3,5-dimethyl-piperidin-1-yl)-2-fluoro-pyrimidine (M26.1), Cyclopropaneacetic acid, 1,1′-[(3S,4R,4aR,6S,6aS,12R,12aS,12bS)-4-[[(2-cyclopropylacetyl)oxy]methyl]-1,3,4,4a,5,6,6a,12,12a,12b-decahydro-12-hydroxy-4,6a,12b-trimethyl-11-oxo-9-(3-pyridinyl)-2H,11H-naphtho[2,1-b]pyrano[3,4-e]pyran-3,6-diyl]ester (M26.2) and 8-(2-Cyclopropylmethoxy-4-trifluoromethyl-phenoxy)-3-(6-trifluoromethyl-pyridazin-3-yl)-3-aza-bicyclo[3.2.1]octane (M26.3).

35. A method as set forth in claim 26 wherein the pesticide is fipronil.

36. A method as set forth in claim 26 wherein the solvent is chosen from the group consisting of acetone, alcohols, esters, ethers and mixtures thereof

37. A method as set forth in claim 26 wherein the co-solvent is a mixture of isoparaffins.

38. A method as set forth in claim 26 wherein the thickening agent is selected from the xantham gum, guar gum, gum arabic, alginin, gum tragacanth, sodium alginate and bentonite clay.

39. A method as set forth in claim 26 wherein the thickening agent is bentonite clay.

40. A method as set forth in claim 26 wherein the composition is dispensed onto a vertical surface and wherein less than about 25% by weight of the pesticide composition after being applied and after drying dislodges from the vertical surface after about 72 hours of application.

41. A method as set forth in claim 26 wherein the composition is dispensed onto a vertical surface and wherein the pesticide composition is capable of adhering to a vertical surface such that substantially none of the pesticide composition after being applied and after drying dislodges from the vertical surface after about 72 hours of application.

42. A ready-to-use pesticide composition comprising a solvent, a pesticide dissolved in the solvent, particulate cellulose material suspended in the solvent and a thickening agent, wherein the particulate cellulose material is selected from the group consisting of microcrystalline cellulose, purified cellulose, α-cellulose and mixtures thereof.

43. A ready-to-use pesticide composition as set forth in claim 42 comprising a co-solvent.

44. A ready-to-use pesticide composition as set forth in claim 43 wherein the thickening agent is not functional in the solvent alone and the thickening agent is functional in the co-solvent.

45. A ready-to-use pesticide composition as set forth in claim 42 wherein the cellulose is micro-crystalline cellulose.
